(19) United States
(12) Patent Application Publication
(10) Pub. No.: US 2004/0221123 A1
(43) Pub. Date: Nov. 4, 2004

(54) Virtual data switch and method of use

(76) Inventors: Wai Tung Lam, Jericho, NY (US); Ronald Steven Niles, Teaneck, NJ (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/428,471

(22) Filed: May 2, 2003

(51) Int. Cl. G06F 12/00; G06F 12/10

(52) U.S. Cl. 711/202; 711/154

(57) ABSTRACT

The invention includes a smart switch for facilitating the transfer of data between clients and storage devices wherein the switch has enhanced command response capabilities which allow the various levels of autonomous operation independent of a controlling server. Additionally, the controlling server is alleviated of the need to have all data transfers between the storage devices and the clients pass through the server.

### FIELD OF THE INVENTION

This invention pertains to the field of mass data storage, and, in particular to multi-disk data stores managed by a server to receive and deliver data to and from multiple client computers.

### BACKGROUND OF THE INVENTION

Storage virtualization is the process of using software to manage physical storage devices by allocating different chunks of the storage spaces made available by these devices to user clients as virtual disk volumes. These virtual disk volumes look like actual disks to the clients, but they may actually be just a sector of a physical storage device, or a combination of sectors from several different physical storage devices.

The goal of storage virtualization is to standardize and centralize storage management in a heterogeneous storage/host environment. It provides a simple and systematic method for clients to perform actions such as data replication, snapshot, and mirroring. Virtualization decouples the relationship between physical storage devices and logical volumes, allowing clients to present customized logical volume sizes to their applications based upon needs rather than physical limitations.

One way to perform storage virtualization is to have the server software reside in the data path between the storage devices and the clients accessing the storage resources. This way, the server software will have direct control of the storage resources, which allows implementation of a high level of data security, and, because the physical storage devices hide behind the server software, the latter will be able to present truly open-platform storage service.

Such configurations are well known in the prior art, and a typical prior art topology is shown in FIG. 1. In FIG. 1, client 10 sends a “request” data frame 12 to switch 20 via anyone of a number of ports to which it may be connected. Switch 20 determines that request 12 needs to be sent to server 30 on which server software having virtualization functionality is running and, therefore, forwards request data frame 12 to the port connected to server 30. Server 30 analyzes request 12 to determine the actual portions of physical storage devices 40 which comprise the requested virtual disk volume in data request 12. Server 30 then produces appropriate request data frames for operations necessary to store or retrieve data to or from one or more physical storage devices 40.

One weakness of prior art configurations such as the one described is that when data passes through server 30, the internal PCI bus 16 of server 30 is used for the data transfer. To be able to transfer data between clients 10 and physical storage devices 40, server 30 will need to allocate buffer space 18 to temporarily store the data while it decides where the data needs to be transferred. Consequently, for each write data transfer, the data will pass through PCI bus 16 once to get to data buffer 18 and another time to go from data buffer 18 to one or more storage devices 40. For read operations, the data will be read from one or more storage devices 40 into data buffer 18 via PCI bus 16, and will pass through PCI bus 16 another time when it is sent client 10. During high level operations such as mirroring, the data, it is possible that the data may pass through PCI bus 16 even more times.

PCI bus 16 has limited bandwidth and, in addition to transferring data, needs to support communications internal to server 30, such as between the CPU and memory thereof. Having the data transfers compete for access to PCI bus 16 puts great stress on the resources of server 30 and unavoidably slows down its performance. PCI bus 16, with limited bandwidth, thus becomes a bottleneck for the entire data transfer operation. Because server 30 does not need the actual data to complete the transfers, allowing the data to compete for bus bandwidth is both unnecessary and inefficient. It therefore makes sense to try to eliminate the movement of data through server 30 by allowing server 30 to coordinate, not participate, in the data transfer process. The result would be an optimal storage virtualization solution.

It would be therefore be desirable to have a configuration wherein the data never passes through server 30, to avoid the identified bottleneck, and which further does not overly complicate the firmware of switch 20, to facilitate easy upgradeability and a simple hardware implementation.

### SUMMARY OF THE INVENTION

This invention teaches the implementation and use of an enhanced switch, called a virtual switch, with support for multiple protocols to directly perform a portion of the storage virtualization function by integrating the a portion of the server functionality within the switch. The virtual switch performs a portion of the virtualization function itself, can interpret certain data transfer requests and act upon them, buffers data, and relies on the server software to supply intelligence and make decisions, both for normal data transfers and for higher level functions, such as replication, mirroring, snapshot, and backup. The server, on the other hand, relies on the enhanced capabilities of the switch, which are improved over prior art switches, to handle bulky data transfers directly between clients and storage devices, such that the server software will no longer need to act as a go-between and which therefore eliminates expensive and wasteful data transfers in the server. As such, the bottleneck inherent in prior art devices is eliminated.

The enhanced capabilities of the virtual switch are implemented by a set of advanced operations built in to the switch firmware, in addition to the regular switch capabilities, such that it can communicate with the server software and accept guidance therefrom. There are two embodiments of the invention, one having a less sophisticated enhancement And one having a more sophisticated enhancement over prior art switches.

The set of new operations according to this invention will let the virtual switch add entries to its simple name server (SNS) table that represent virtual devices instead of actual ones, alter SCSI command frames when necessary, automatically process simple requests by itself, and communicate with the server to handle more complicated requests. These tasks are enhancements to those functions provided by a typical prior art switch, and thus will not introduce needless complexity into the switch hardware and firmware, unlike many other types of advanced-capability prior art switches.

The virtual switch of this invention, in its preferred embodiment, supports various protocols, including fibre channel, iSCSI, and SCSI. It allows the enablement of both in-band and out-of-band services without the pitfalls inherent in each method. The enhanced operational capability of the switch will allow the server software to carry out more complex features such as mirroring and snapshots in a much more direct way. The result is an integrated solution that offers maximized flexibility and efficiency.

### BRIEF DESCRIPTION OF THE DRAWINGS

FIG. 1 is a schematic drawing of a prior art implementation of a typical data switch.

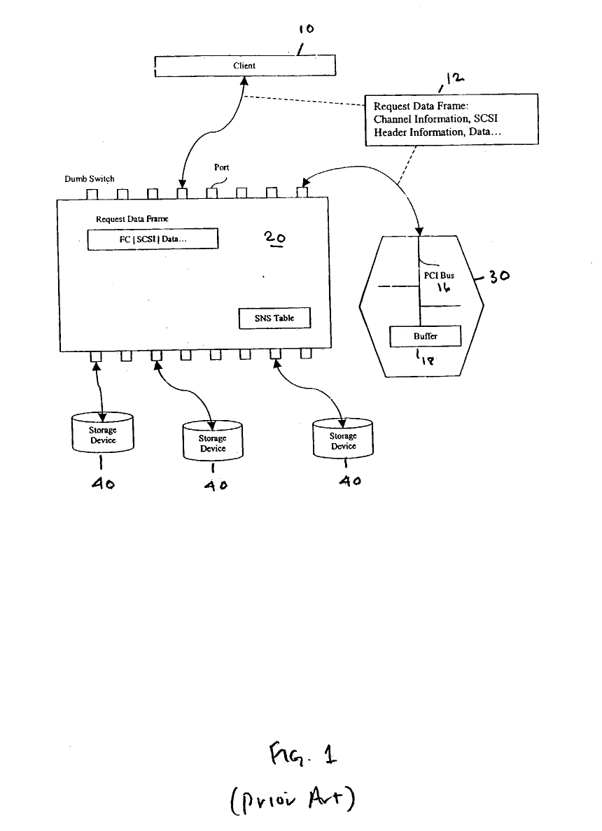

FIG. 2 is a schematic representation of the present invention.

FIG. 3 shows the flow of a typical client request for one embodiment of the invention.

FIG. 4 shows the flow of a typical client request for a more sophisticated embodiment of the invention.

### DETAILED DESCRIPTION OF THE INVENTION

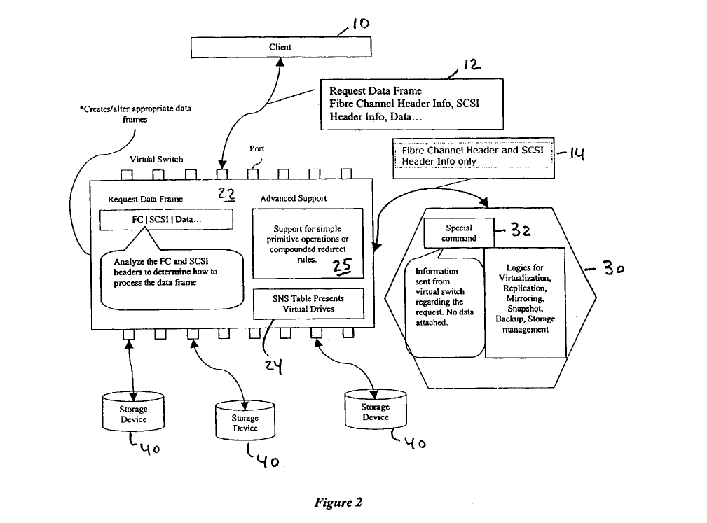

The topology of the present invention is shown in FIG. 2. The present invention utilizes a switch having enhanced hardware and firmware capabilities, which are leveraged to eliminate the need for data to pass through the server. First, enhanced switch 22 is able to modify its internal SNS table 24 to include virtual volumes. As such the virtual volumes become completely transparent to clients 10. Second, the switch contains support 25 for the execution of simple higher level operations and the capability of having rules for complex higher-level functionality pre-built into the switch firmware or downloaded into the switch from server 30.

Physical storage devices 40 are physically connected to ports on switch 22. Clients 10 are logically connected to ports on switch 22. Clients may be connected, for example, through the Internet to a line that is physically connected to a port on switch 22. Server 30 is connected to switch 22 via a special connection which may be implemented as a port or using other means well known in the art. In the preferred embodiment of the invention, physical connections to the ports of switch 22 are made via fibre channel, but any other well known media and associated transport protocol may be used.

Because all requests pass through enhanced switch 22, enhanced switch 22 has the opportunity to intercept each request and perform the steps necessary to eliminate the need for data to pass through server 30. When a request of a certain protocol is detected by switch 22, the actual drive read and/or write commands, which, in the preferred embodiment will be SCSI protocol commands, are usually encapsulated inside the frames of that request. The switch can analyze these commands and modify the SCSI commands or construct new SCSI commands to achieve the desired result. While the preferred embodiment of the invention assumes SCSI drives are being used, the invention is in no way meant to be limited to drives using the SCSI protocol.

When a client request data frame 12 is received from a client 10, enhanced virtual switch 22 analyzes the transport-specific request header information as well as the SCSI header information. This allows switch 22 to determine what the purpose of the request is. With built in support for a set of relatively simple higher level operations, which are discussed later, switch 22 is able to handle simple requests on its own by altering and/or creating request data frames to send to actual storage devices 40. For more complicated operations, switch 22 will put information regarding the request into a special command 32 which is passed to server 30. Server 30 then makes a determination regarding which steps are required to complete the desired operation and sends appropriate special commands back to switch 22 to utilize the built in support functions of the switch to complete the request. These exchanges of special commands 32 between switch 22 and server 30 never include the actual data being transferred, because it is not necessary. In this manner, the bulky data never is transmitted through the PCI bus of server 30 and therefore, the bottle neck identified in the prior art is eliminated.

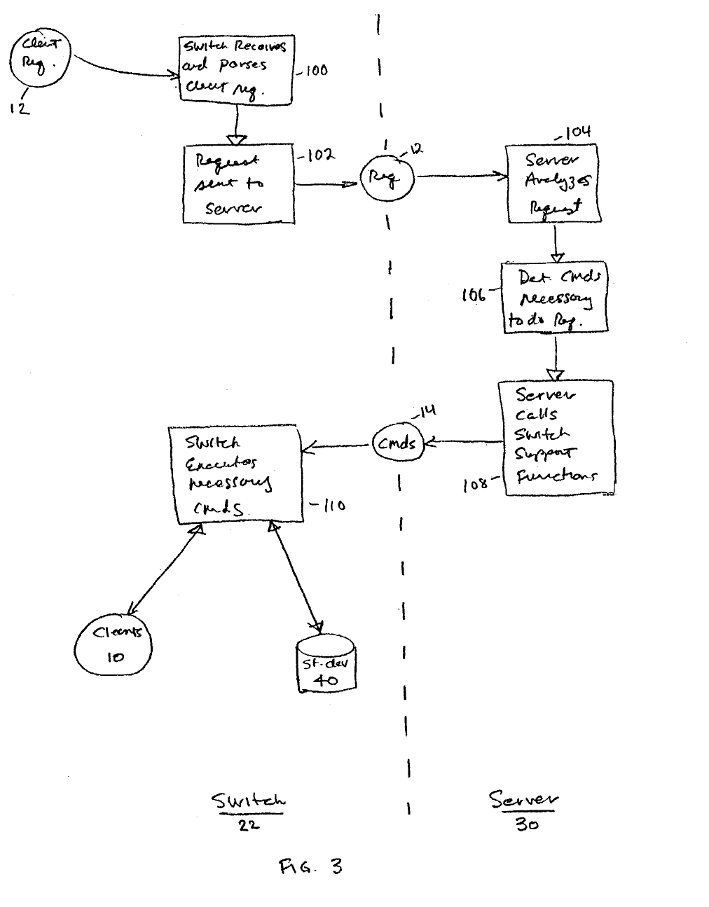

There are two embodiments of the present invention. In the first embodiment, the operation of which is shown in FIG. 3, a less sophisticated version of switch 22 is utilized. In box 100, a client request 12 is received and parsed by switch 22. At 102-, the command information of request 12 is sent to server 30 for analysis. Server 30, at 104, analyzes the request and, at 106, determines which commands need to be sent to switch 30 to alter and/or direct request 12 to accomplish the desired result. At 108, the command sequence 14 is passed to virtual switch 22. At 110, the switch 22 executes the commands directed by server 30, which may cause data to be transferred between clients 10 and physical storage devices 40.

As an example, if a client wishes to read data from virtual drive X, which is composed of portions of physical drives A, B and C, a request for a read from drive X is sent to switch 22. The request would contain, for example, a SCSI command for a read from drive X. Switch 22 sends the request to server 30, where server 30 determines that reads from drives A, B and C are necessary to complete the request for a read from virtual drive X. Server 30 tells switch 22 to modify the SCSI command for a read from drive X to a read from drive A, and also instructs switch 22 to add SCSI commands for reads from drives B and drive C. The switch executes the read operations from drives A, B and C, establishes connections to the ports to which those drives are connected, and directs the data read from the physical drives to the port to which client 10 is connected. As a result, from the point of view of client 10, a single read from drive X has occurred.

The enhancements to switch 22 basically fall into two levels of sophistication corresponding to the two embodiments of the invention. The second and more sophisticated level requires more intelligence on the part of switch 22 and consists of more complex procedures. The two levels of enhancements to switch 22 are discussed in more detail below.

The first level consists of support for primitive commands wherein each command would be able to invoke the switch to perform a simple unit action (level one commands). These are commands that the server can use to instruct the switch to carry out certain straight forward actions or more complex functions, such as in the example above for a read from virtual drive X. In addition, switch 22, when enhanced with the second level of commands, will also be able to call on the primitive commands of the first level to complete more complex operations.

The first level of commands are as follows:

SNS Table Entry: Tells switch 22 to enter an entry into SNS table 24, with information about the device to be entered given by the caller. Using this command, the software will be able to allocate virtual storage devices and present them to clients 10 as available target drives. This feature also enables a zoning feature utilizing virtual drives. Zoning restricts the view of each client to certain drives attached to the switch, either physical or virtual.

Client Request Hold: Tells switch 22 to send a hold command to client 10 after client 10 has initiated a request using a query command frame. Conditions of the hold will be given by the caller. Using this command, disk writes performed by clients who require snapshots can be carried out by first sending the command to the client so that the client will refrain from sending out the write data immediately. Allows the software to perform the snapshot function before letting new changes write to the disk.

Alter Write Command Frame: Tells switch 22 to change an existing SCSI write command frame, using destination device/sector/block, data pointer, and data length given by the caller. Using this command, a write request from client 10 specifying a location on a virtual device can be mapped to a real storage device 40. The altered SCSI write command frame can then be passed to the right port by the switch, where real device 40 will accept the disk write.

New Write Command Frame: Tells switch 22 to create a brand new SCSI write command frame, using destination device/sector/block, data pointer, and data length given by the caller. When data write for a virtual disk needs to be mapped to several real devices 40, this command can be used to tell switch 22 to create extra write command frames for the extra disk writes needed. The data pointer and data length passed to each command frame will reflect the appropriate section of the entire data to be written. Additionally, this command can be used to create extra copies of data. For example, when mirroring is in effect, whenever a disk write command frame is received, the software can issue the previous command to direct data to the main disk, and simultaneously issue the current command, passing in the mirroring disk as the destination and specifying the data pointer-and data length to include the entire data. This way, the data will be written to both the main and mirroring disk at practically the same time.

Alter Read Command Frame: Tells switch 22 to change an existing SCSI read command frame, using target device/sector/block, buffer pointer, and data length given by the caller. Using this command, a read request from client 10 specifying a location on a virtual device can by mapped to real device 40. The altered SCSI read command frame can then be passed to the right port by switch 22, where real device 40 connected to the port will process the disk read.

New Read Command Frame: Tells switch 22 to create a new SCSI read command frame, using target device/sector/block, buffer pointer, and data length given by the caller. When data read from a virtual disk maps to reads from two or more real devices 40, this command can be used to tell switch 22 to create extra read command frames for the extra disk reads needed. The resulting data buffers, each filled by a disk read, can then be collected in the correct order. Additionally, this command can be used to perform procedures such as data replication where the software will need to be able to read in data from real device 40 and then send the data across an IP network to a remote replicating disk.

Status Reply: Tells switch 22 to create a SCSI command frame as a status reply to a request from client 10. Status codes, target client, and other necessary parameters for the reply frame will be given by the software. Using this command, software will be able to reply to client 10 after the requested action has been taken, such as after a write/read request.

Note that, once the switch has modified existing SCSI commands, or created new SCSI commands, these commands are then embedded in request frames of the correct transport protocol, such as for fibre channel before they are sent to the drive.

A second embodiment of the invention is also specified. The second embodiment is a more sophisticated version of the first embodiment wherein higher level commands are able to be processed by switch 22.

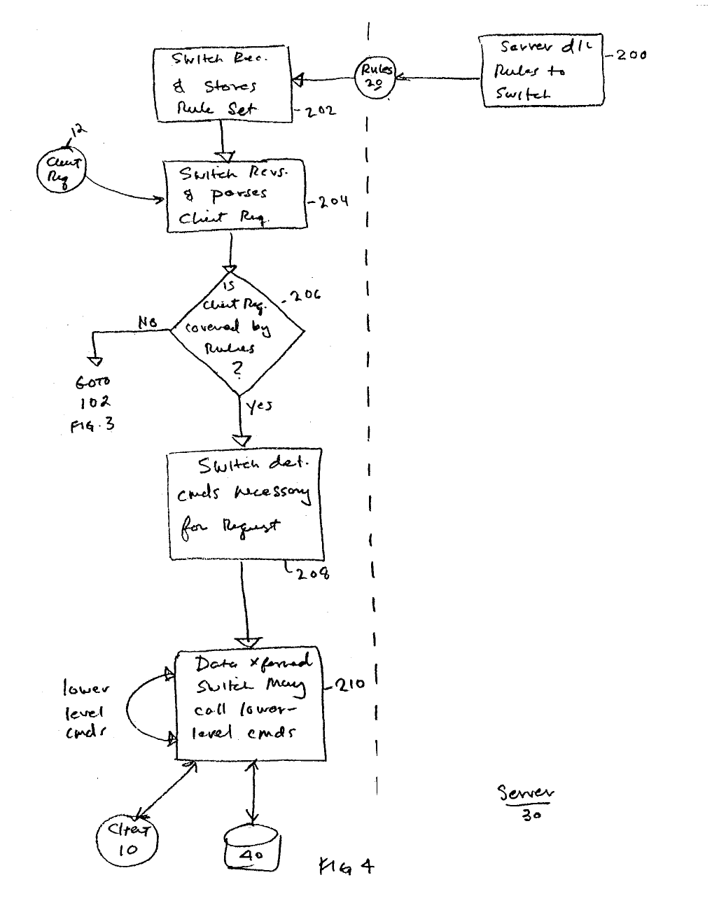

The second embodiment of the invention is shown in FIG. 4. Server 30, at 200, is able to dynamically download a set of predefined rules 20 to switch 22 regarding how to handle various types of client requests 12. These rules are received by switch 22 and stored internally at 202. Alternatively, switch 22 may have the pre-defined rules 20, or a portion of the pre-defined rules 20 built into its firmware.

When a client request 12 arrives from client 10, switch 22 parses the command at 204. At 206, switch 22 determines if the request is covered by one of the rules downloaded to switch 22 from server 30 or pre-built into the firmware of switch 22. If not, processing proceeds as if the switch were a level one switch at 102 in FIG. 3. If switch 22 has a rule to cover client request 12, switch 22 determines, at 208, which commands are necessary to carry out request 12 without further communication between switch 22 and server 30. Thus, switch 22 has taken over the role of server 30 for the subset of functions for which a rule 20 has been supplied by server 30. At 210, data is transferred between clients 10 and physical storage devices 40. Note that switch 22, in the process of handling client request 12, may call one or more of its own level one commands, just as server 30 would do if no rules 20 had been downloaded to switch 22.

In another embodiment of the invention, switch 22 will also be able to perform more advanced operations (level two commands). These operations can be triggered by specific events, where switch 22 determines the conditions, asks for the help of server 30 when necessary, and carries out the appropriate steps. The following are some examples of such level two operations.

Client Request Categorization: Switch 22 determines the nature of received client requests 12 and proceeds accordingly. If the request does not involve data transfer, but is a query of some kind, it should be directly forwarded to server 30 for processing. The switch should be able to carry out simple data transfers on its own, and only communicates with server 0.30 when necessary.

Direct Disk Operations: When a read or write request is received, switch 22 processes certain straightforward disk operations without assistance from server 30, assuming that switch 22 has access to the virtual storage map created by server 30. The map contains a mapping between virtual volumes and physical storage devices 40, and maybe downloaded from server 30 to switch 22 as a rule 20. Consequently, switch 22 can use this map to process many disk reads and writes without the intervention of server 30.

For example, when a disk read comes in, switch 22 can first look at the command frame, determine the source virtual drive, and then look at the virtual storage map to find one or more real disks 40 from which the data can be retrieved. If the map indicates only one real disk 40, the virtual switch can call the “Alter Read Command Frame” command to get data from that storage device 40. If the map indicates more than one disk, the virtual switch could call the “Alter Read Command Frame” command and one or more “New Read Command Frame” commands to read sections of the required data from the appropriate places on the actual storage devices 40. The data is buffered in the internal buffer 26 of switch 22 as it is read from various portions of actual storage devices 40. After the disk reads have been completed, the sections can then be submitted to client 10 in the correct order, also determinable using the virtual storage map.

Additionally, the virtual storage map could also include special instructions on certain disk operations. Complex operations such as snapshot and replication may require extra processing before a disk operation can be carried out. Switch 22 can look for these special instructions, and if not found, can communicate with server 30 for succeeding steps.

Support for Complex Operations: If information on which device has which complex operations (i.e., mirroring, snapshot, etc.) enabled is available, then switch 22 should be able to automatically carry out those complex operations whenever possible. For example, when a write request comes in, switch 22 can look for the destination in the command frame and determine what feature operations are enabled for that destination. If, for example, mirroring is enabled, switch 22 can use the “Alter Write Command Frame” command to send data to the main destination disk, and also use the “New Write Command Frame” command to send the entire data to the secondary, mirroring disk.

Support for Multiple Protocols: Switch 22 is able to support various protocols, such as, for example, fibre channel, iSCSI, and SCSI. When switch 22 connects devices using different protocols, it should be able to take a request command frame of one protocol and translate it internally to the protocol used by the destination. For example, switch 22 may be connected to an IP network where clients 10 issue iSCSI requests made up of SCSI commands encapsulated in IP packets. Storage devices 40, on the other hand, may be connected to switch 22 using fibre channel, or any other means known in the art. Thus, when an iSCSI request arrives at switch 22, switch 22 will be able to take apart the IP packet, extract the SCSI command, and repackage it to suit the transport protocol of the specific selected channel.

Based on these two embodiments, the level of commands which can be handled by switch 22 can be modified based on the topology of the system and the level of the command being handled. As an example, in one embodiment switch 22 may be able to handle simple requests for reads and writes to actual or virtual volumes while server 30 must be consulted for more sophisticated commands such as replication mirroring and snapshot functions.

This invention addresses the issue of data unnecessarily taking up PCI bus bandwidth while doing in-band storage virtualization and the proposed solution that introduces a new, smarter switch to help in the virtualization process by directly transferring data between the client and the real devices. The PCI bus of the machine running the service provider software will then be relieved of much data traffic, and the software will only need to act as the coordinator of data transfers without actually seeing the data itself. For the enhanced switch to support the proposed solution, a set of new level one enhanced operations were defined that included support for simple, primitive commands, as well as more complex, level two operations. The virtual switch with its enhanced capabilities will assist the server software to carry out an enhanced, more efficient storage virtualization service.

We claim:

1. A system for providing data storage service to multiple clients comprising:
one or more physical storage devices;
a switch connected to said one or more storage devices; and
a server, in communication with said switch,
wherein said server interprets requests for data transfers to or from virtual storage devices received by said switch from said clients and sends commands to said switch instructing said switch to transfer data to or from said one or more physical storage devices.

2. The system of claim 1 further wherein said switch can be instructed to alter or create commands to transfer data between one or more of said physical storage devices and said client from which said request has been received.

3. The system of claim 1 further comprising a table, in said switch, which contains mappings of virtual storage devices to said one or more physical storage devices.

4. The system of claim 3 wherein client access to said virtual or physical drives can be limited on a drive-by-drive basis.

5. The system of claim 1 wherein said server can download rules for certain operations to said switch.

6. The system of claim 1 wherein said switch has rules for certain operations in firmware built into said switch.

7. The system of claim 5 wherein one of said operations is the translation of requests for data transfers involving virtual storage devices to commands for data transfers to or from said one or more physical storage devices.

8. The system of claim 5 wherein said switch sends requests for which it has no rule to said server for interpretation.

9. The system of claim 1 wherein said switch has an enhanced command set including commands selected from the group consisting of altering write commands, creating-new write commands, altering read commands, creating new read commands and instructing said clients to hold.

10. The system of claim 3 wherein said switch can add new mappings to said table.

11. The system of claim 5 wherein said switch can interpret requests from said clients to determine if it has a rule for handling said requests or whether said request must be sent to said server for handling.

12. The system of claim 7 wherein said switch handles all simple data transfers involving virtual or physical drives without intervention from said server.

13. The system of claim 5 wherein said switch can handle requests for transfers to or from mirrored virtual or physical drives and transfers to or from mirroring drives without intervention from said server

14. The system of claim 1 wherein said switch can translate commands from one protocol to another.

15. The system of claim 14 wherein said protocols are selected from a group comprising iSCSI, SCSI and fibre channel.

16. The system of claim 2 wherein no data is transferred between said switch and said server.

17. In a switch connected to one or more clients; one or more physical storage devices and a server, a method of operation comprising the steps of:
receiving requests including a command portion and a data portion from one of said clients;
sending said command portion of said request to said server for interpretation;
receiving commands from said server to implement said request from said client; and
effecting the transfer of data between said one or more physical storage devices and said client, based on said commands received from said server.

18. The method of claim 17 wherein said requests can include requests for data transfers to or from virtual storage devices.

19. The method of claim 18 wherein said server performs a mapping from said virtual storage device to one or more of said physical storage devices and further wherein said commands from said server to said switch include commands to alter said client request and/or to create new requests for data transfers to said one or more of said physical drives, based on said mapping.

20. In a switch connected to one or more clients, one or more physical storage devices and a server, a method of operation comprising the steps of:
receiving one or more rules for the handling of complex requests from said server;
receiving requests including a command portion and a data portion from one of said clients;
interpreting said command portion of said request to determine if a rule for that request has been received from said server;
processing those commands for which a rule has been received from said server and sending said command portion of said request to said server for interpretation for those requests for which a rule has not been received;
receiving commands from said server to implement those requests for which no rule has been received from said server; and
effecting the transfer of data between said one or more physical storage devices and said client, based on said interpretation of said request or on commands received from said server.

21. The method of claim 20 wherein said requests can include requests for data transfers to or from virtual storage devices and further wherein said switch has rules for the handling such requests without intervention from said server.

22. The method of claim 21 wherein said switch includes a table containing mappings between virtual storage devices and one or more of said physical storage devices.
